(19) United States
(12) Patent Application Publication
(10) Pub. No.: US 2012/0200670 A1
(43) Pub. Date: Aug. 9, 2012

(54) Method and apparatus for a disparity limit indicator

(75) Inventor: Lachlan D. Pockett, Tampere (FI)

(73) Assignee: Nokia Corporation

(21) Appl. No.: 12/931,596

(22) Filed: Feb. 4, 2011

(51) Int. Cl. H04N 13/02

(52) U.S. Cl. 348/46; 348/E13.074

(57) ABSTRACT

In accordance with an example embodiment of the present invention, an apparatus is disclosed. The apparatus includes a stereoscopic camera system, a user interface, and a disparity range system. The user interface includes a display screen. The user interface is configured to display on the display screen an image formed by the stereoscopic camera system. The image corresponds to a scene viewable by the stereoscopic camera system. The disparity range system is configured to detect a disparity for the scene. The disparity range system is configured to provide an indication on the display screen in response to the detected disparity.

### TECHNICAL FIELD

The invention relates to a disparity limit indicator for an electronic device.

### BACKGROUND

Electronic devices include many different features. As such, features for electronic devices are increasing in number and electronic devices provide for a better user experience. Some considerations when providing these features in a portable electronic device may include, for example, compactness, suitability for mass manufacturing, durability, and ease of use. Increase of computing power of portable devices is turning them into versatile portable computers, which can be used for multiple different purposes. Therefore versatile components and/or features are needed in order to take full advantage of capabilities of mobile devices.

One area gaining popularity in the consumer market is the use of stereoscopic displays (or three-dimensional [3D] displays). Accordingly, as consumers demand increased functionality from the electronic device, there is a need to provide an improved device having increased capabilities, such as three-dimensional capabilities, while maintaining robust and reliable product configurations.

### SUMMARY

Various aspects of examples of the invention are set out in the claims.

According to a first aspect of the present invention, an apparatus is disclosed. The apparatus includes a stereoscopic camera system, a user interface, and a disparity range system. The user interface includes a display screen. The user interface is configured to display on the display screen an image formed by the stereoscopic camera system. The image corresponds to a scene viewable by the stereoscopic camera system. The disparity range system is configured to detect a disparity for the scene. The disparity range system is configured to provide an indication on the display screen in response to the detected disparity.

According to a second aspect of the present invention, a method is disclosed. A minimum disparity of a scene viewable through a stereoscopic camera system is detected. A maximum disparity of the scene is detected. A disparity range is calculated based, at least partially, on the detected minimum disparity and the detected maximum disparity. An indication corresponding to the disparity range is displayed on a display screen.

According to a third aspect of the present invention, computer program product is disclosed. The computer program product includes a computer-readable medium bearing computer program code embodied therein for use with a computer, the computer program code including: Code for processing an image with a processor to determine a disparity range corresponding to the image. The image is configured to be captured by a stereoscopic camera system. Code for providing a real-time indication at a user interface of the camera system in response to the determined disparity range.

### BRIEF DESCRIPTION OF THE DRAWINGS

For a more complete understanding of example embodiments of the present invention, reference is now made to the following descriptions taken in connection with the accompanying drawings in which:

FIG. 1 is a front view of an electronic device incorporating features of the invention;

FIG. 2 is a rear view of the electronic device shown in FIG. 1;

FIGS. 3-6 are partial views of the electronic device shown in FIG. 1 with one example of a disparity range system;

FIGS. 7-10 are partial views of the electronic device shown in FIG. 1 with another example of a disparity range system;

FIG. 11 is a partial view of the electronic device shown in FIG. 1 with another example of a disparity range system;

FIG. 12 is a front view of an electronic device incorporating features of the invention;

FIG. 13 is a block diagram of an exemplary method of the device shown in FIGS. 1, 12; and

FIG. 14 is a schematic drawing illustrating components of the electronic device shown in FIGS. 1, 12.

### DETAILED DESCRIPTION OF THE DRAWINGS

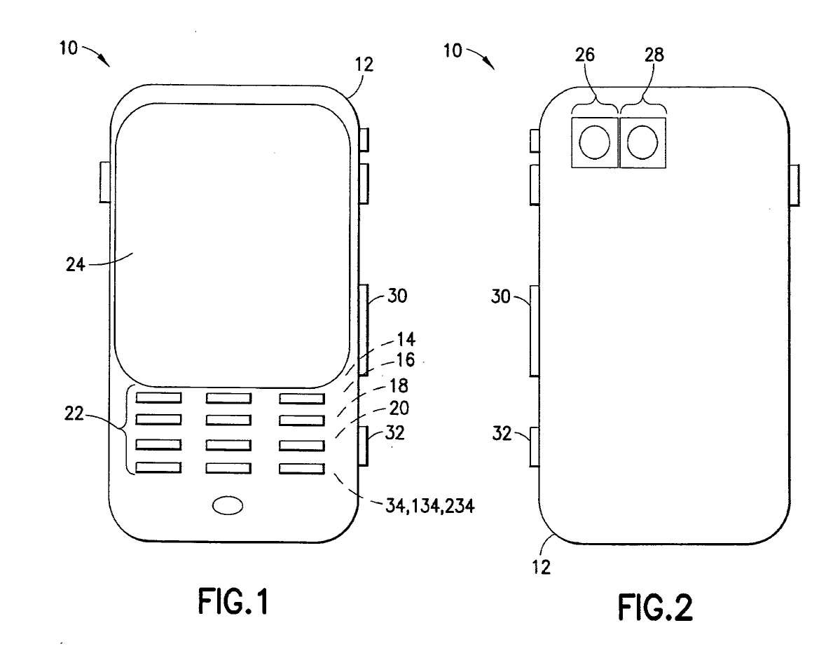

An example embodiment of the present invention and its potential advantages are understood by referring to FIGS. 1 through 14 of the drawings.

Referring to FIG. 1, there is shown a front view of an electronic device 10 incorporating features of the invention. Although the invention will be described with reference to the exemplary embodiments shown in the drawings, it should be understood that the invention can be embodied in many alternate forms of embodiments. In addition, any suitable size, shape or type of elements or materials could be used.

According to one example of the invention, the device 10 is a multi-function portable electronic device. However, in alternate embodiments, features of the various embodiments of the invention could be used in any suitable type of portable electronic device such as a mobile phone, a gaming device, a music player, a notebook computer, or a personal digital assistant, for example. In addition, as is known in the art, the device 10 can include multiple features or applications such as a camera, a music player, a game player, or an Internet browser, for example. The device 10 generally comprises a housing 12, a transmitter 14, a receiver 16, an antenna (connected to the transmitter 14 and the receiver 16), electronic circuitry 20, such as a controller (which could include a processor, for example) and a memory for example, within the housing 12, a user input region 22 and a display 24. The display (or user interface) 24 could also form a user input section, such as a touch screen. It should be noted that in alternate embodiments, the device 10 can have any suitable type of features as known in the art.

The electronic device 10 further comprises cameras 26, 28 which are shown as being rearward facing (for example for capturing images and video for local storage) but may alternatively or additionally be forward facing (for example for video calls). The cameras 26, 28 may be controlled by a shutter actuator 30 and optionally by a zoom actuator 32. However, any suitable camera control functions and/or camera user inputs may be provided.

The cameras 26, 28 are stereoscopic (or three-dimensional [3D]) cameras. According to some embodiments of the invention, at least two images are simultaneously taken with the parallel cameras in order to generate a stereoscopic presentation.

The following terms that may be found in the specification and/or the drawing figures are defined as follows:

Parallax is the horizontal offset due to a viewpoint change (for example, how much foreground objects seem to move to the side as you move your head to the side).

Disparity is the total difference between two images on the stereoscopic display. This difference can come from many sources, including scene parallax, image offset, other ISP actions, and camera misalignments. Disparity may be measured in physical distance on the display (mm) or in pixels.

Minimum disparity is the greatest crossed ([−] negative value) difference (disparity) between the two images for a common object point, represented by the closest object in the scene.

Maximum disparity is the greatest uncrossed (+) difference (disparity) between the two images for a common object point, represented by the furthest object in the scene.

Disparity range is the total difference in disparity between the closest object (−) and the furthest object (+). This is impacted by the range of objects in the scene, camera FOV, image cropping/scaling (effectively digital zoom), and display mechanics. If the disparity range is too large than the image is unusable.

Image offset/Euclidian offset is horizontally moving one image relative to the other, thus changing all disparities equally, this then impacts the minimum and maximum disparity, though the total disparity range is still the same.

The electronic device (or user equipment [UE]) further comprises a disparity range system 34. The disparity range system 34 provides a disparity range indicator on the camera user interface 24 to indicate the disparity range and/or the minimum and maximum disparity in the scene about to be captured, and indicates how this falls within a ‘safe zone’. For example, this then enables a user of the device 10 to change the scene, take a step back, or adjust the camera zoom accordingly to get a good three-dimensional effect that is within a comfortable disparity range.

The disparity range system 34 is configured to use range image processing methods to detect the minimum and maximum disparity from the stereoscopic pair. According to some embodiments of the invention the range image processing methods may include block matching, scale-invariant feature transform (SIFT) analysis, Fast Fourier transform (FFT), or any other suitable image processing method. Additionally, in some other embodiments of the invention the minimum and maximum disparity can also be obtained by other means such as a depth sensor, or a time of light (TOL) [or time of flight (TOF)] sensor, and then disparity calculations may be performed based on the known camera field of view (FOV). It should be noted that, this is not a full disparity map (which is computationally intensive), it is ascertaining the values of maximum and minimum disparity. However, in alternate embodiments, any suitable type of disparity map may be provided.

An appropriate disparity range can be defined for a specific display considering aspects such as viewing distance and crosstalk levels, for example. This can be performed by the display manufacturer, or other display usability testing, and is generally known information for the device. However, any suitable method for determining the disparity range may be provided. The difference between the minimum and maximum disparity are then used to calculate the disparity range present in the scene. This is then displayed in an intuitive manner on the user interface (such as a range indicator on the display screen 24, for example) by the disparity range system 34.

Displays generally can only show a certain limit of crossed and uncrossed disparity before there starts to be accommodation-convergence mismatch problems. This problem is exemplified for handheld devices where the short display viewing distance means the ¼ dioptre flexibility of the visual system is quickly exceeded. Numerous other visual science and human factors impact the range of disparity comfortably viewed on a display. The disparity range system 34 simplifies these human factors into a set range on the display 24.

In order to achieve the appropriate disparity on the display, several factors can be controlled in the image processing and content generation. The range of objects in a scene impact the parallax detected by the camera, infinite distance objects form parallel light, thus falling on the same point on each sensor, the closest in the scene forms a specific angle relative to the cameras. Thus the angle of light is both scene dependant and dependant on the camera separation. This angle relative to the camera forms a number of pixels on the image sensor, which is dependant on the camera zoom (FOV/f) and the sensor resolution. This parallax is then scaled with image scaling and then offset by a horizontal Euclidian image shift to form the disparity that is viewed on the display. As convention goes; crossed disparity is negative and uncrossed disparity is positive.

When a scene contains objects that are too close for a stereoscopic camera separation, then generally there will be too great a range in parallax detected by the cameras, thus making it difficult to achieve comfortable on-screen disparity for both foreground and background objects.

The factors can be controlled in designing a stereoscopic camera system are the horizontal Euclidian offset that impact both near (−ev disparity) and far (+ev disparity) objects alike to try to adjust so both are within the comfortable range. The camera separation can be specified for one specific scene (for example for objects 1 meter (m) to infinity), though if the scene contains a too great a range of objects for that camera separation, then it is difficult to make the whole scene comfortable to view. Adjusting the Euclidian offset to make the foreground comfortable can make the background difficult to view, and adjusting so the background is viewable can make the foreground difficult to view. Additionally zoom reduces the camera field of view (FOV) and so scales up the camera detected parallax. In the above example, it can be acceptable for a scene to have objects in a range of about 0.5 meter (m) to about 1 meter (m) by increasing the offset, the key here is that the dioptre range of objects does not exceed that which the stereoscopic camera can handle. Note that here the inverse of the distance (or dioptre distance) is important, as a 0.5 m object causes twice the angle, and hence twice the parallax as a 1 m object, which has twice the parallax as a 2 m object. The change from 0.5 m to 0.25 m then doubles the parallax again.

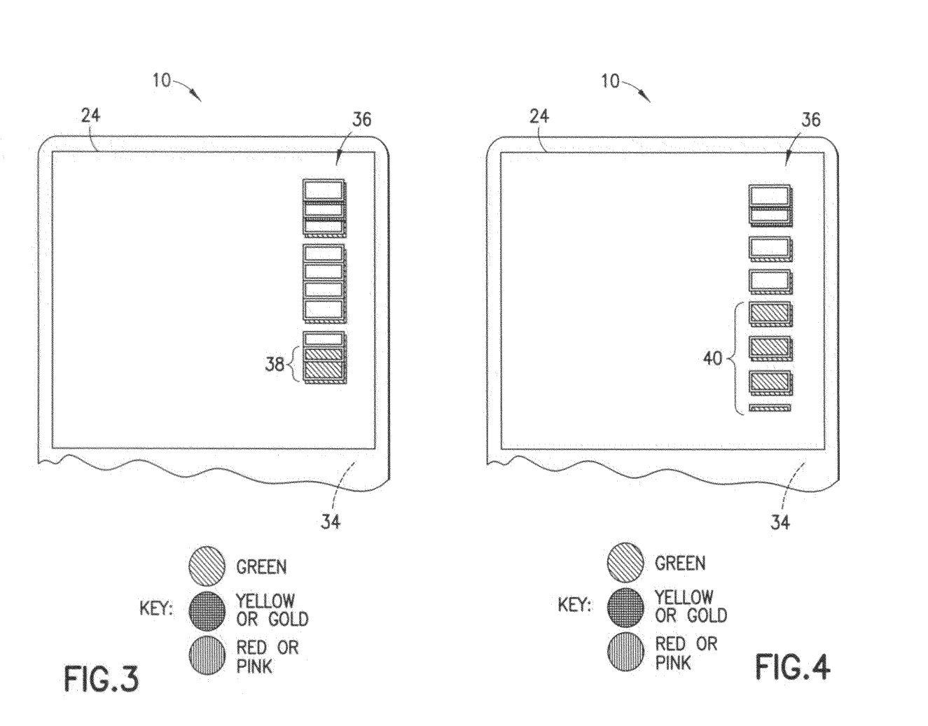

According to one example of the invention, the disparity range system 34 includes a bar indicator 36 at a right side portion of the display 24 (see FIGS. 3-6). However, it should be noted that the bar indicator may be provided at any suitable portion of the display. In this example of the invention, the bar indicator (or disparity range indicator) 36 comprises a column of bars (similar to a volume indicator of a stereo system) on the display (or user interface) showing green (illustrated with diagonal line hatching) for comfortable disparities, yellow (illustrated with horizontal and vertical line hatching) for borderline disparities, and red (illustrated with vertical line hatching) for too much disparity. This indicator may, for example, only indicate the absolute disparity range, as that is a key aspect that can not be fixed later and dictates if the photo will be usable. While the minimum and maximum disparity are not critical as this can always be trivially fixed at time of shooting or in post-processing by changing the Euclidian offset.

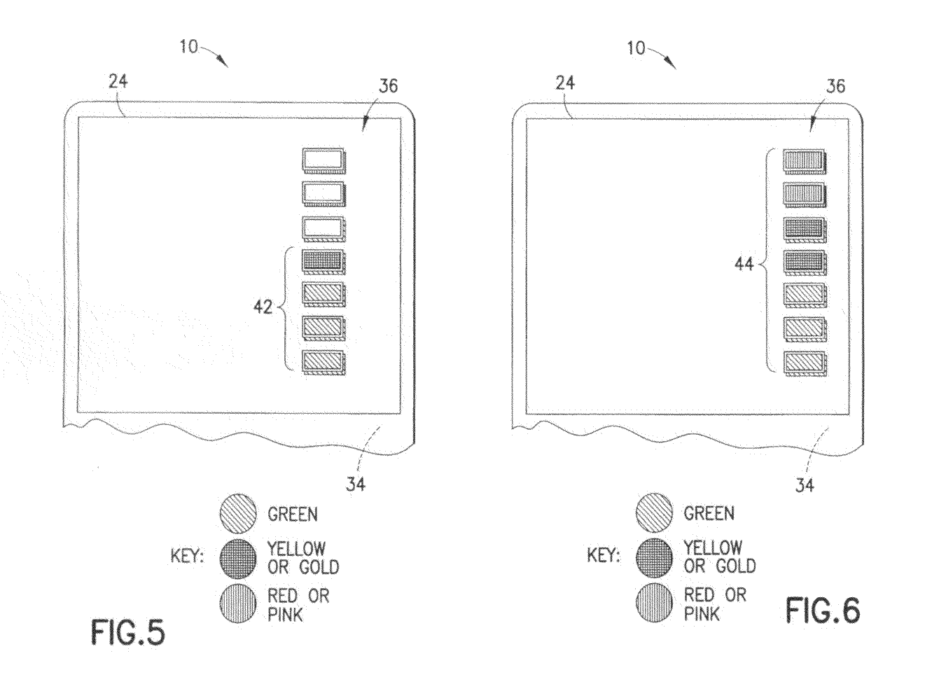

For example, as shown in FIG. 3, the column of bars (or plurality of bars) 36 on the display 24 may indicate that there is not enough disparity range (flat scene) in the image of the scene to be captured by the cameras by displaying a portion 38 of the bars in “green”. As shown in FIG. 4, the column of bars on the display 24 may indicate that there is a ‘good’ (or acceptable) disparity range in the image of the scene to be captured by the cameras by displaying another portion of the bars in “green”. As shown in FIG. 5, the column of bars on the display 24 may indicate that there is a borderline troublesome disparity range in the image of the scene to be captured by the cameras by displaying another portion 42 of the bars in “green” and “yellow”. As shown in FIG. 6, the column of bars on the display 24 may indicate that there is too much disparity range (unusable image) in the image of the scene to be captured by the cameras by displaying another portion 44 of the bars in “green”, “yellow”, and “red”.

According to some embodiments of the invention, the camera separation can be designed so it can handle objects from 2 m to an infinite distance. This allows for 0.5 dioptre range in distances. Thus an image of a scene having 1 m to 2 m range of objects can be captured, and nothing more than 2 m (1/1−1/2=0.5). However, if a user of the device 10 attempted to capture an image of a scene containing objects from 1 m to 2.5 m, then it would contain a too large range of distances (1/1−1/2.5=0.6 dioptre, which is greater than 0.5), thus this image would be unusable. In this situation (which may occur, for example when novice stereoscopic photographers take pictures of objects that are too close to the camera), the disparity range system 34 would provide the indication on the display 24 as shown in FIG. 6 (indicating too much disparity range).

Now if the user of the device 10 would take a small step backwards, then the same scene would contain objects from 1.5 m to 3 m, which would be acceptable to view on the display (1/1.5−1/3=0.666−0.333=0.333 dioptre, which is less than 0.5). With the small step backwards to achieve the appropriate disparity range, the disparity range system 34 would provide the indication on the display 24 as shown in FIG. 4 (indicating an acceptable disparity range). Thus the user of the device can make this scene acceptable for image capture by taking the small step backwards, and receiving a real-time indication on the display 24 by the disparity range system 34.

Alternatively, it should be noted that a user of the device may possibly modify the image framing, scene composition, or move any offending near object from the scene to alleviate the disparity problem. Similarly, the same applies in the opposite direction where a user attempts to get the most three-dimensional effect so the user moves forwards, or changes the scene composition to achieve the greater three-dimensional effect.

Additionally it should be noted that the form of camera zoom can also impact the field of view (FOV) of the camera, and hence the number of pixels on the display that represent a certain angle in the camera.

While various exemplary embodiments of the invention have been described in connection with the bar indicator 36 at suitable portions of the display 24, it should be noted that in some alternate embodiments, the bar indicator may be provided at a location other than the display 24. For example, in some embodiments the bar indicator 36 may be provided at a second display of the device. In some other embodiments, the bar indicator 36 may be provided at a location separate and spaced from the display 24, such as a series of dedicated indicator lights proximate the display, for example. However, these are merely provided as non-limiting examples and the bar indicator 36 may be, in some embodiments of the invention, provided at any suitable location (and/or configuration) separate and spaced from the display 24.

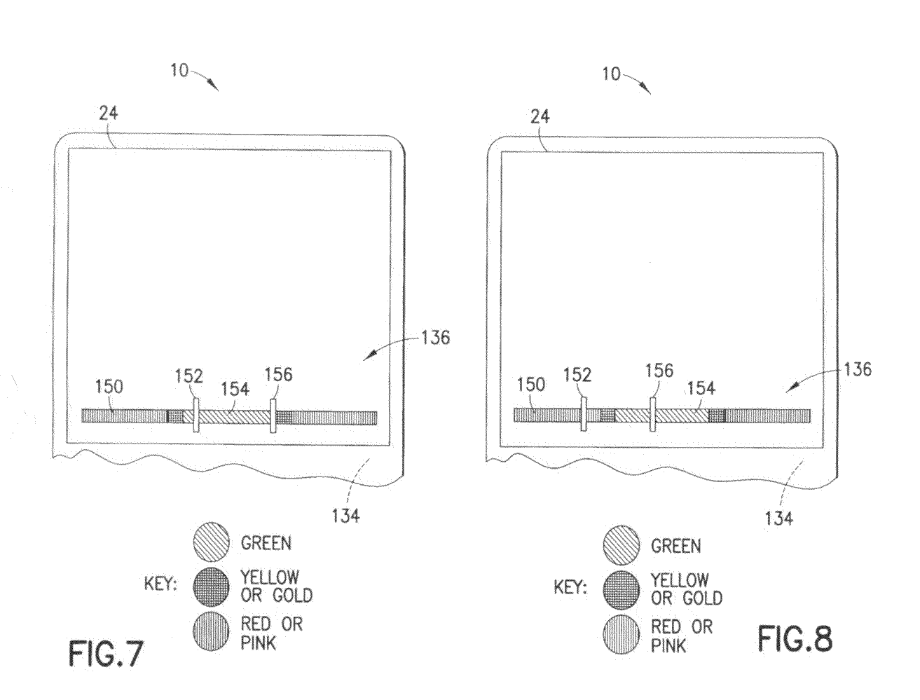

According to another example of the invention, a disparity range system 134 includes a bar indicator 136 provided at a bottom portion of the display 24 (see FIGS. 7-10). However, it should be noted that the bar indicator may be provided at any suitable portion of the display. In this example of the invention, the bar indicator (or disparity range indicator) 136 displays the actual image minimum and maximum disparity on a bar indicating where they lie in respect to the comfortable disparity range. For example, the left end portion of the bar 150 is “red” (illustrated with vertical line hatching) for indicating a crossed disparity (such as when there is a close object, for example). The right end portion of the bar is “red” for indicating an uncrossed disparity (such as when there is a far object, for example). A first marker portion 152 is provided as an indicator for the greatest crossed disparity (related to closest detected object in the scene). A range portion 154 is “green” (illustrated with diagonal line hatching) indicates a disparity range for the screen (such as a comfortable disparity range, for example). A second marker portion 156 is provided as an indicator for the greatest uncrossed disparity (related to furthest object in scene).

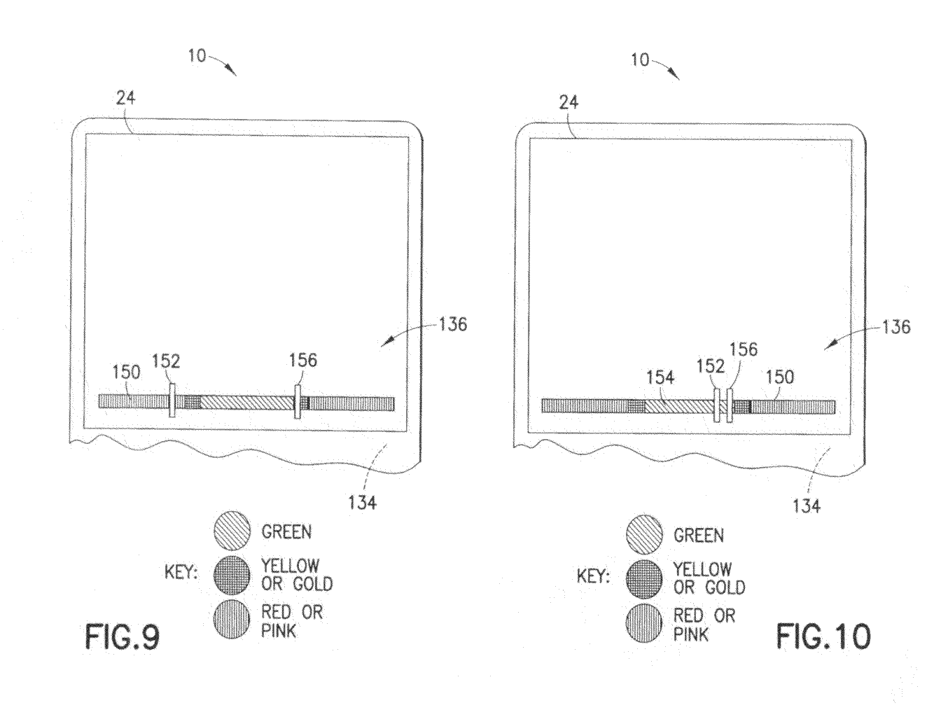

According to some example embodiments of the invention, the disparity range system 134 provides an indicator that not only shows the total disparity range, but where the scene disparities lie in correspondence to the comfortable display disparities. For example, FIG. 7 illustrates a real-time indication where there is a comfortable disparity range for the scene (as the marker portions 156, 156 are within the “green” range portion 154). FIG. 8 illustrates a real-time indication for a scene where the closest object is too close, though because the furthest object is also close to the camera this can be easily fixed with a Euclidian off-set, which will shift both markers equally to the right, thus both will be in the “green” range portion (or zone) 154 (for a comfortable disparity range). FIG. 9 illustrates a real-time indication for a scene where it is impossible to make both marker portions 152, 156 to fit in the “green” range portion 154, thus the user of the device 10 can either change the scene, take a step back, or zoom out to reduce the distance between the marker portions 152, 156. FIG. 10 illustrates a real-time indication for a scene containing only far distant objects, where this generally does not provide an impressive stereoscopic picture, however changing the composition of the scene might make a more interesting image (for three-dimensional purposes). The user of the device 10 could also consider moving closer to the objects in the scene, zooming in, or adding a foreground object to create an interesting scene.

While some examples of the invention have been described in connection with bar indicators having “green”, “yellow”, and/or “red” portions, one skilled in the art will appreciate that the invention is not necessarily so limited and that any suitable configuration or colors for the bar indicator portions may be provided.

While various exemplary embodiments of the invention have been described in connection with the bar indicator 136 at suitable portions of the display 24, it should be noted that in some alternate embodiments, the bar indicator may be provided at a location other than the display 24. For example, in some embodiments the bar indicator 136 may be provided at a second display of the device. In some other embodiments, the bar indicator 136 may be provided at a location separate and spaced from the display 24, such as a dedicated indicator section proximate the display, for example. However, these are merely provided as non-limiting examples and the bar indicator 136 may be, in some embodiments of the invention, provided at any suitable location (and/or configuration) separate and spaced from the display 24.

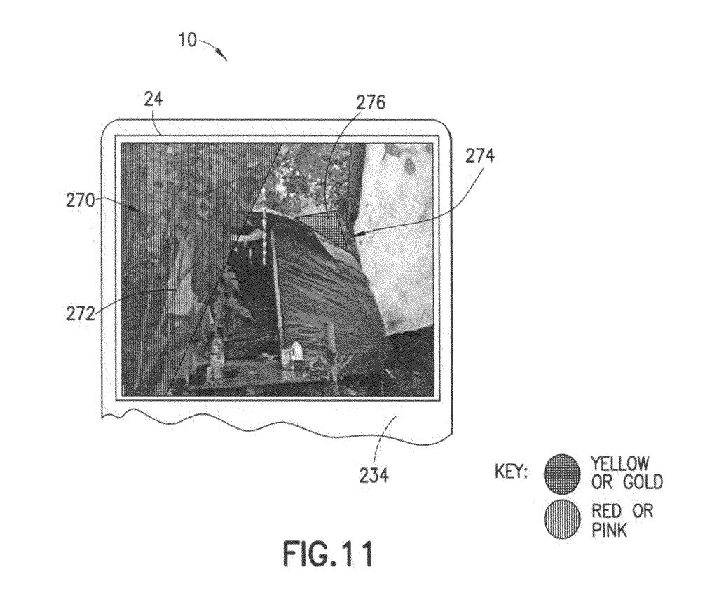

According to another example of the invention, a disparity range system 234 could utilize course disparity mapping (which can generally be more computationally intensive than simply calculating the minimum and maximum disparity), and then shade the scene accordingly (see FIG. 11). In this example of the invention, the disparity map is generated and then used to shade ‘offending’ objects in the scene when displayed on the user interface (or display) 24, thus indicating to the user of the device how the scene could be adjusted to remove offending objects, and adjust object distances accordingly. In this example embodiment the troublesome areas are directly rendered over the viewfinder (or display) 24, and so a separate indicator is not necessarily needed. This allows for the user of the device 10 to know what the offending objects are, for example if the user does not notice a foreground object that is in the corner of the scene and too close to the camera, the disparity range system 234 could then shade that section of the viewfinder in “red” and indicate that this is the offending object, giving intuitive information that enables the photographer to change the scene, or camera settings accordingly to achieve a good stereoscopic photograph.

For example, as shown in FIG. 11, the portion 270 is shaded “red” (illustrated with vertical line hatching) in the display (or viewfinder) 24 as there is a branch 272 in the scene that is too close to the device. This provides a real-time indication (provided by the disparity range system 234) as the user of the device sees the red portion 270 in the display 24, which indicates to the user that a step to the side, for example, can be taken in order to ‘remove’ the offending object 272 from the image (so that by taking the step to the side, the branch 272 is no longer in the image to be captured).

Still referring to FIG. 11, the portion 274 is shaded “yellow” (illustrated with vertical and horizontal line hatching) to indicate extreme disparity problems in a background area 276 of the scene that can result when the user of the device increased the Euclidian image offset instead of taking a step to the side to avoid the branch 272 in the portion 270. Increasing the Euclidian image offset slightly reduces the problem of the branch, but can cause extreme disparity problems in the background (as indicated to the user in the portion 274, as a “yellow” shaded portion of the scene). With this indication, the user of the device 10 may then either remove the front branch 272 and reduce the Euclidian offset, or otherwise change the camera angle so not to have these far distant objects.

According to some other embodiments of the invention, if the shaded “red” portion 270 is identified to be minute (such as comprising a small portion of the image), the user has an option to try to remove the identified disparity problem from the image by performing a “cloning” operation/method (instead of manually stepping to the side). For example, to remove the offending object from the image, the user could select the offending object (identified by the shaded “red” portion 270) prior to capture thus flagging the disparity problem object area. The disparity range system may then be configured to “clone” portions of the image so that once the offending object is selected, the disparity range system may “clone” the pixels ‘behind’ the shaded “red” portion 270 and provide these cloned pixels at the image in order to remove the disparity problem(s). Similarly, if the shaded “yellow” portion 274 is identified to be minute (such as comprising a small portion of the image), the disparity range system may also be configured to “clone” portions of the image so that once the far distant object is selected, the disparity range system may “clone” the pixels ‘in front’ of the shaded “yellow” portion 274 and provide these cloned pixels at the image in order to remove the disparity problem(s).

It should be noted that although the disparity range system has been described above in connection with “red” and “yellow” shaded portions corresponding to offending objects in the scene, alternate embodiments may comprise any suitable color(s), type of shading; or indication on the display.

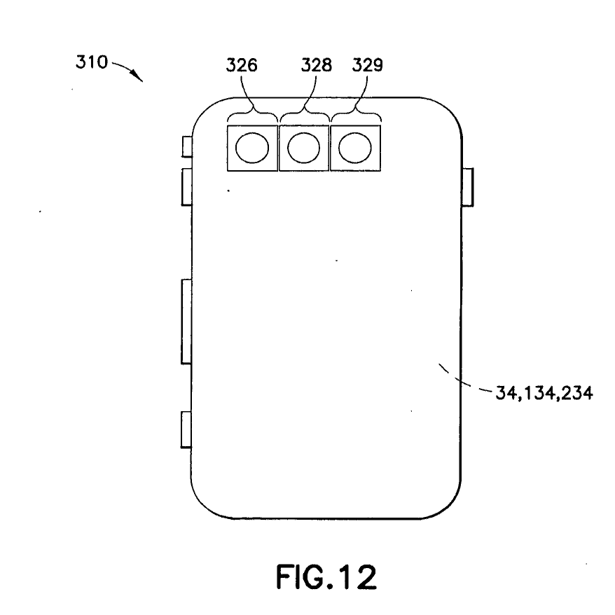

According to some embodiments of the invention, the disparity range system 34, 134, 234 could be used with a three camera system (see FIG. 12). The three-camera system (comprising cameras 326, 328, 329) can alleviate issues with extreme disparity range by changing camera separations, though this is a discrete change, scaling the disparity range down to about 70 percent of its original value. In one embodiment of the invention, such a three-camera system could also have further advantages from this user interface indicator, giving the user of the device 310 a way of having a better understanding of the scene, and so the user can better design the shot to take full advantage of the available disparity range. It should further be noted that according to some other embodiments of the invention, the disparity range system may be used with any suitable number of cameras and/or camera systems.

It should be noted that the disparity range system functionality may be switched ‘on’ or ‘off’ by the user of the device 10. For example, the system may be activated and de-activated in the settings of the device. As shown in figures, the disparity range system may take up some available space on the display and thus a user of the device may de-activate the disparity range system in order to increase the viewable image size on the display. However, this is merely provided as a non-limiting example and the user of the device may activate and de-activate the disparity range system in any suitable manner.

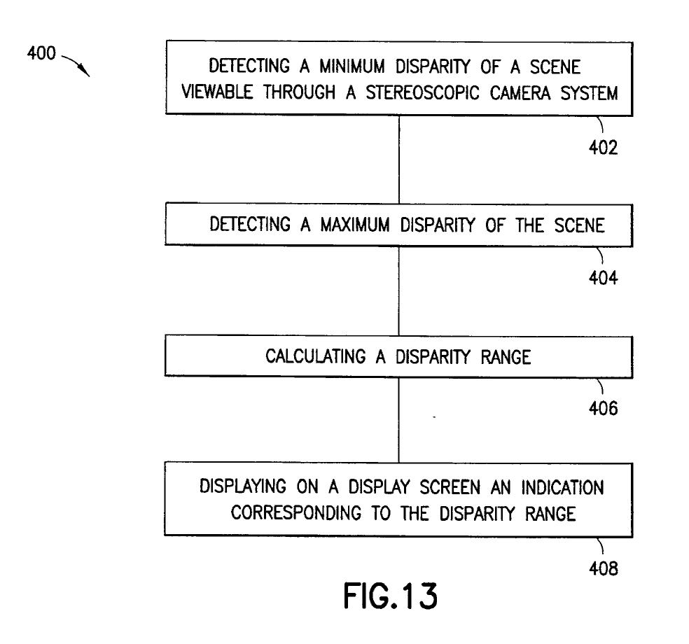

FIG. 13 illustrates a method 400. The method 400 includes detecting a minimum disparity of a scene viewable through a stereoscopic camera system (at block 402). Detecting a maximum disparity of the scene (at block 404). Calculating a disparity range based, at least partially, on the detected minimum disparity and the detected maximum disparity (at block 406). Displaying on a display screen an indication corresponding to the disparity range (at block 408). It should be noted that the illustration of a particular order of the blocks does not necessarily imply that there is a required or preferred order for the blocks and the order and arrangement of the blocks may be varied. Furthermore it may be possible for some blocks to be omitted.

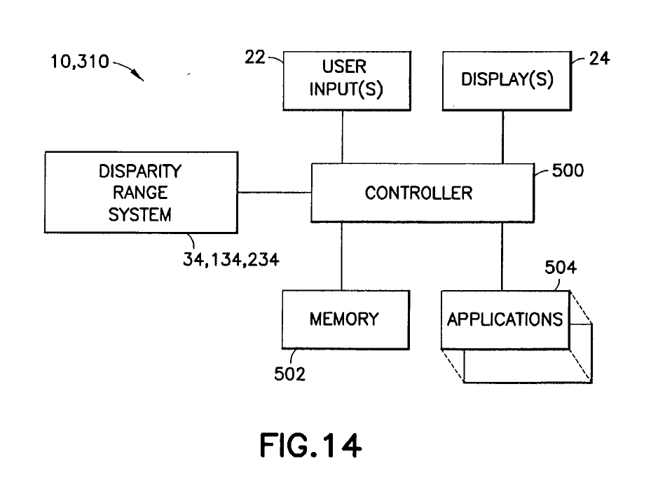

Referring now also to FIG. 14, the device 10, 310 generally comprises a controller 500 such as a microprocessor for example. The electronic circuitry includes a memory 502 coupled to the controller 500, such as on a printed circuit board for example. The memory could include multiple memories including removable memory modules for example. The device has applications 504, such as software, which the user can use. The applications can include, for example, a telephone application, an Internet browsing application, a game playing application, a digital camera application, a map/gps application, for example. These are only some examples and should not be considered as limiting. One or more user inputs 22 are coupled to the controller 500 and one or more displays 24 are coupled to the controller 500. The disparity range system 34, 134, 234 is also coupled to the controller 500. Additionally, the cameras 26, 28 (and/or 326, 328, 329) are also be connected the disparity range system and/or the controller. The device 10, 310 may be programmed to automatically provide a disparity limit. However, in an alternate embodiment, this might not be automatic.

Without in any way limiting the scope, interpretation, or application of the claims appearing below, a technical effect of one or more of the example embodiments disclosed herein is providing a useful user interface tool for devices having stereoscopic capabilities, which enable users of the device to better control depths in the scene and ensure pictures are easy to view. Another technical effect of one or more of the example embodiments disclosed herein is providing an improved user experience when operating the device in a three-dimensional mode wherein an increased percentage of images captured by the user have an acceptable range of disparities when using the disparity range system (as opposed to having many ‘first’ images with too large range of disparities when capturing images with conventional stereoscopic devices). Another technical effect of one or more of the example embodiments disclosed herein is alerting the user of the device to the principle of comfortable disparities (which many users generally would not be aware of) and eases users into the use of stereo photography. Another technical effect of one or more of the example embodiments disclosed herein is providing ease of use for more experienced users, giving the experienced user the tools to create more artistic stereoscopic photos. Another technical effect of one or more of the example embodiments disclosed herein is indicating a disparity range and/or minimum and maximum disparity in a scene to be captured and also indicating how the scene falls in the safe zone, on a camera user interface (UI). Another technical effect of one or more of the example embodiments disclosed herein is providing for an improved three-dimensional effect within a comfortable disparity range. Another technical effect of one or more of the example embodiments disclosed herein is enabling a novice stereo photographer to have a faster learning curve to achieve good three dimensional images, while also providing a good indicator that an experienced stereo photographer may use for achieving interesting artistic effects.

Additional technical effects of any one or more of the exemplary embodiments provide a disparity limit indicator having significant improvements when compared to conventional configurations wherein the stereoscopic camera systems have a pair of buttons that are used to control the image offset. Many of these conventional devices allow for offsetting the entire scene disparity, though this generally does not give any indication of the range of disparity, and with a camera separation that is generally too large, it causes a various problems with extreme disparity from objects that are too close to the camera. These conventional configurations allow for disparity offset by buttons, though do not have any indicator or information helping a user of the device to control this to an appropriate amount, and knowing how close objects can be to the camera.

Further technical effects of any one or more of the exemplary embodiments provide for overcoming problems that ‘common’ users (such as user's inexperienced with three-dimensional image capture) can experience as ‘common’ users generally do not understand how disparities impact the scene, and if there will be a too large range of disparities for the scene, thus resulting in poor pictures, and the conventional three-dimensional experience can all become too complicated, and unattractive. However, exemplary embodiments of the invention allow for ease of use and enhanced user experience for the common user in three-dimensional image capture modes. Even experienced stereo photographers greatly advantage with the various exemplary embodiments of the invention for having an easy way of telling what kind of disparities are present in the scene, and thus how to take the best quality stereoscopic images.

Below are provided further descriptions of various non-limiting, exemplary embodiments. Various aspects of one or more exemplary embodiments may be practiced in conjunction with one or more other aspects or exemplary embodiments. That is, the exemplary embodiments of the invention, such as those described immediately below, may be implemented, practiced or utilized in any combination (for example, any combination that is suitable, practicable and/or feasible) and are not limited only to those combinations described herein and/or included in the appended claims.

In one exemplary embodiment, a method of indicating disparity range and/or minimum and maximum disparity in a scene to be captured and also indicating how the scene falls in the safe zone for getting ‘good’ three-dimensional (3D) effects, on camera user interface (UI) is disclosed.

In another exemplary embodiment, an apparatus, comprising: a stereoscopic camera system; a user interface comprising a display screen, wherein the user interface is configured to display on the display screen an image formed by the stereoscopic camera system, wherein the image corresponds to a scene viewable by the stereoscopic camera system; and a disparity range system configured to detect a disparity for the scene, and wherein the disparity range system is configured to provide an indication on the display screen in response to the detected disparity.

An apparatus as above, wherein the disparity range system is configured to detect a minimum disparity for the scene.

An apparatus as above, wherein the disparity range system is configured to detect a maximum disparity for the scene.

An apparatus as above, wherein the indication on the display screen comprises a real-time indication.

An apparatus as above, wherein the indication on the display screen comprises a bar indicator comprising a plurality of displayable bars, wherein the display range system is configured to display a first portion of the plurality of bars in response to a first detected disparity, and wherein the display range system is configured to display a second portion of the plurality of bars in response to a second detected disparity.

An apparatus as above, wherein the indication on the display screen comprises a bar indicator, wherein the bar indicator comprises a first marker portion, a second marker portion, and a range portion, wherein the first marker portion corresponds to a closest detected object in the scene, wherein the second marker portion corresponds to a furthest detected object in the scene, and wherein the range portion corresponds to a disparity range for the scene.

An apparatus as above, wherein the indication on the display screen comprises a first shaded portion, wherein the first shaded portion overlaps a section of the image on the display screen, and wherein the first shaded portion corresponds to a detected object in the scene.

An apparatus as above, wherein the disparity range system is configured to use a range image processing method for detecting the disparity.

An apparatus as above, wherein the apparatus comprises a mobile phone.

In another exemplary embodiment, a method comprising: detecting a minimum disparity of a scene viewable through a stereoscopic camera system; detecting a maximum disparity of the scene; calculating a disparity range based, at least partially, on the detected minimum disparity and the detected maximum disparity; and displaying on a display screen an indication corresponding to the disparity range.

A method as above, wherein the indication on the display screen comprises a bar indicator comprising a plurality of displayable bars, wherein a first portion of the plurality of bars is displayed in response to a first detected disparity, and wherein a second portion of the plurality of bars is displayed in response to a second detected disparity.

A method as above, wherein the indication on the display screen comprises a bar indicator, wherein the bar indicator comprises a first marker portion, a second marker portion, and a range portion, wherein the first marker portion corresponds to a closest detected object in the scene, wherein the second marker portion corresponds to a furthest detected object in the scene, and wherein the range portion corresponds to the disparity range for the scene.

A method as above, wherein the indication on the display screen comprises a first shaded portion, wherein the first shaded portion overlaps a section of an image of the scene on the display screen, and wherein the first shaded portion corresponds to a detected object in the scene.

A method as above, wherein the calculating the disparity range further comprises using a range image processing method for calculating the disparity range.

A method as above, wherein the indication on the display screen comprises a real-time indication.

In another exemplary embodiment, a computer program product comprising a computer-readable medium bearing computer program code embodied therein for use with a computer, the computer program code comprising: code for processing an image with a processor to determine a disparity range corresponding to the image, wherein the image is configured to be captured by a stereoscopic camera system; and code for providing a real-time indication at a user interface of the camera system in response to the determined disparity range.

A computer program product as above, wherein the real-time indication at the user interface comprises a bar indicator comprising a plurality of displayable bars, wherein a first portion of the plurality of bars is displayed in response to a first detected disparity, and wherein a second portion of the plurality of bars is displayed in response to a second detected disparity.

A computer program product as above, wherein the real-time indication at the user interface comprises a bar indicator, wherein the bar indicator comprises a first marker portion, a second marker portion, and a range portion, wherein the first marker portion corresponds to a closest detected object shown in the image, wherein the second marker portion corresponds to a furthest detected object shown in the image, and wherein the range portion corresponds to the disparity range for the image.

A computer program product as above, wherein the real-time indication at the user interface comprises a first shaded portion, wherein the first shaded portion overlaps a section of the image shown at the user interface, and wherein the first shaded portion corresponds to a detected object in the image.

A computer program product as above, wherein the computer program code further comprises code for determining a minimum disparity for the image, code for determining a maximum disparity for the image, and wherein the code for processing comprises a range image processing method.

It should be understood that components of the invention can be operationally coupled or connected and that any number or combination of intervening elements can exist (including no intervening elements). The connections can be direct or indirect and additionally there can merely be a functional relationship between components.

As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Embodiments of the present invention may be implemented in software, hardware, application logic or a combination of software, hardware and application logic. The software, application logic and/or hardware may reside on the device or a server. If desired, part of the software, application logic and/or hardware may reside on the device, and part of the software, application logic and/or hardware may reside on the server. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIGS. 1-14. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus, comprising:
a stereoscopic camera system;
a user interface comprising a display screen, wherein the user interface is configured to display on the display screen an image formed by the stereoscopic camera system, wherein the image corresponds to a scene viewable by the stereoscopic camera system; and
a disparity range system configured to detect a disparity for the scene, and wherein the disparity range system is configured to provide an indication on the display screen in response to the detected disparity.

2. An apparatus as in claim 1 wherein the disparity range system is configured to detect a minimum disparity for the scene.

3. An apparatus as in claim 1 wherein the disparity range system is configured to detect a maximum disparity for the scene.

4. An apparatus as in claim 1 wherein the indication on the display screen comprises a real-time indication.

5. An apparatus as in claim 1 wherein the indication on the display screen comprises a bar indicator comprising a plurality of displayable bars, wherein the display range system is configured to display a first portion of the plurality of bars in response to a first detected disparity, and wherein the display range system is configured to display a second portion of the plurality of bars in response to a second detected disparity.

6. An apparatus as in claim 1 wherein the indication on the display screen comprises a bar indicator, wherein the bar indicator comprises a first marker portion, a second marker portion, and a range portion, wherein the first marker portion corresponds to a closest detected object in the scene, wherein the second marker portion corresponds to a furthest detected object in the scene, and wherein the range portion corresponds to a disparity range for the scene.

7. An apparatus as in claim 1 wherein the indication on the display screen comprises a first shaded portion, wherein the first shaded portion overlaps a section of the image on the display screen, and wherein the first shaded portion corresponds to a detected object in the scene.

8. An apparatus as in claim 1 wherein the disparity range system is configured to use a range image processing method for detecting the disparity.

9. An apparatus as in claim 1 wherein the stereoscopic camera system comprises at least two cameras.

10. An apparatus as in claim 1 wherein the apparatus comprises a mobile phone.

11. A method, comprising:
detecting a minimum disparity of a scene viewable through a stereoscopic camera system;
detecting a maximum disparity of the scene;
calculating a disparity range based, at least partially, on the detected minimum disparity and the detected maximum disparity; and
displaying on a display screen an indication corresponding to the disparity range.

12. A method as in claim 11 wherein the indication on the display screen comprises a bar indicator comprising a plurality of displayable bars, wherein a first portion of the plurality of bars is displayed in response to a first detected disparity, and wherein a second portion of the plurality of bars is displayed in response to a second detected disparity.

13. A method as in claim 11 wherein the indication on the display screen comprises a bar indicator, wherein the bar indicator comprises a first marker portion, a second marker portion, and a range portion, wherein the first marker portion corresponds to a closest detected object in the scene, wherein the second marker portion corresponds to a furthest detected object in the scene, and wherein the range portion corresponds to the disparity range for the scene.

14. A method as in claim 11 wherein the indication on the display screen comprises a first shaded portion, wherein the first shaded portion overlaps a section of an image of the scene on the display screen, and wherein the first shaded portion corresponds to a detected object in the scene.

15. A method as in claim 11 wherein the calculating the disparity range further comprises using a range image processing method for calculating the disparity range.

16. A method as in claim 11 wherein the indication on the display screen comprises a real-time indication.

17. A computer program product comprising a computer-readable medium bearing computer program code embodied therein for use with a computer, the computer program code comprising:
code for processing an image with a processor to determine a disparity range corresponding to the image, wherein the image is configured to be captured by a stereoscopic camera system; and
code for providing a real-time indication at a user interface of the camera system in response to the determined disparity range.

18. A computer program product as in claim 17 wherein the real-time indication at the user interface comprises a bar indicator comprising a plurality of displayable bars, wherein a first portion of the plurality of bars is displayed in response to a first detected disparity, and wherein a second portion of the plurality of bars is displayed in response to a second detected disparity.

19. A computer program product as in claim 17 wherein the real-time indication at the user interface comprises a bar indicator, wherein the bar indicator comprises a first marker portion, a second marker portion, and a range portion, wherein the first marker portion corresponds to a closest detected object shown in the image, wherein the second marker portion corresponds to a furthest detected object shown in the image, and wherein the range portion corresponds to the disparity range for the image.

20. A computer program product as in claim 17 wherein the real-time indication at the user interface comprises a first shaded portion, wherein the first shaded portion overlaps a section of the image shown at the user interface, and wherein the first shaded portion corresponds to a detected object in the image.

21. A computer program product as in claim 17 wherein the computer program code further comprises code for determining a minimum disparity for the image, code for determining a maximum disparity for the image, and wherein the code for processing comprises a range image processing method.
